(19) United States
(12) Patent Application Publication
(10) Pub. No.: US 2025/0217313 A1
(43) Pub. Date: Jul. 3, 2025

(54) REDUCE INTERPOLATION OPERATIONS

(71) Applicant: Arm Limited, Cambridge (GB)

(72) Inventors: Balaji VENU, Cambridge (GB); Metin Gokhan ÜNAL, Gamston (GB); Giacomo GABRIELLI, Cambridge (GB); Mbou EYOLE, Soham (GB)

(21) Appl. No.: 18/397,757

(22) Filed: Dec. 27, 2023

(51) Int. Cl. G06F 15/80

(52) U.S. Cl. CPC G06F 15/8053

(57) ABSTRACT

Apparatuses, methods, and non-transitory computer-readable media are disclosed. One example concerns a reduce interpolation channel-wise instruction to trigger a reduce interpolation channel-wise operation. The reduce interpolation channel-wise operation comprises: selecting a pair of vectors from a range of source vectors in dependence on a first portion of each element of an interpolation vector; a weighted addition of that element from the pair of vectors, wherein a weighting of the weighted addition is dependent on a second portion of that element of the interpolation vector; and storing a result of the weighted addition in that element of a destination vector. Another example concerns a 2D selection instruction to trigger a 2D selection operation comprising, for each vector element: selecting a selected vector from a range of source vectors, wherein the selected vector is selected in dependence on an element value of that element of an index vector; and copying that element from the selected vector of the range of source vectors to that element of a destination vector.

### TECHNICAL FIELD

The present disclosure relates to data processing. In particular, the present disclosure relates to the performance of reduce interpolation operations.

### DESCRIPTION

A data processing apparatus may be required to perform reduce interpolation operations in which multiple input data items (typically representative of a set of input pixels) are processed to generate one output data item (typically representative of an output pixel).

### SUMMARY

In one example embodiment described herein there is an apparatus comprising:
decoder circuitry responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing circuitry responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

In another example embodiment described herein there is a method comprising:
operating decoder circuitry which responds to a reduce interpolation channel-wise instruction by generating control signals to trigger a reduce interpolation channel-wise operation, wherein the reduce interpolation channel-wise instruction specifies a range of source vectors, an interpolation vector, and a destination vector, each vector having a number of elements; and
operating processing circuitry which responds to the control signals by performing the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

In another example embodiment described herein there is a method comprising:
operating decoder circuitry which responds to a 2D selection instruction to generate control signals to trigger a 2D selection operation, wherein the 2D selection instruction specifies a range of source vectors, an index vector, and a destination vector, each vector having a number of elements; and
operating processing circuitry which responds to the control signals to perform the 2D selection operation comprising, for each element of the number of elements:
   selecting a selected vector of the range of source vectors, wherein the selected vector is selected in dependence on an element value of that element of the index vector; and
   copying that element from the selected vector of the range of source vectors to that element of the destination vector.

In another example embodiment described herein there is a non-transitory computer-readable medium storing program instructions for controlling a host data processing apparatus to provide an instruction execution environment comprising:
decoder program logic responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing program logic responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

In another example embodiment described herein there is a non-transitory computer-readable medium storing program instructions for controlling a host data processing apparatus to provide an instruction execution environment comprising:
decoder program logic responsive to a 2D selection instruction to generate control signals to trigger a 2D selection operation, wherein the 2D selection instruction specifies a range of source vectors, an index vector, and a destination vector, each vector having a number of elements; and
processing program logic responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

### BRIEF DESCRIPTION OF THE DRAWINGS

The present invention will be described further, by way of example only, with reference to embodiments thereof as illustrated in the accompanying drawings, in which:

FIG. 1 schematically illustrates multiple input channels being processed to generate a single output channel;

FIG. 2 schematically illustrates an apparatus in accordance with some examples;

FIG. 3 schematically illustrates an apparatus responsive to a reduce interpolation channel-wise instruction in accordance with some examples;

FIG. 4 shows a sequence of steps that are taken when performing a reduce interpolation channel-wise operation according to the method of some examples;

FIG. 5 schematically illustrates the use of a vector of interpolation data to combine multiple input vectors into a single output vector in accordance with some examples;

FIG. 6 schematically illustrates a compute unit comprising a complex reduce engine, a stencil engine, and a simple reduce engine in accordance with some examples;

FIG. 7 schematically illustrates some operations carried out by a complex reduce engine in accordance with some examples;

FIG. 8 schematically illustrates a 2D selection operation in accordance with some examples;

FIG. 9 schematically illustrates an apparatus responsive to a 2D selection instruction in accordance with some examples;

FIG. 10 shows a sequence of steps that are taken when performing a 2D selection operation according to the method of some examples;

FIG. 11 schematically illustrates a neural engine in accordance with some examples;

FIG. 12 schematically illustrates a vector engine in accordance with some examples; and

FIG. 13 schematically illustrates a general-purpose computer which may support the implementation of some examples.

### DESCRIPTION OF EXAMPLE EMBODIMENTS

Before discussing the embodiments with reference to the accompanying figures, the following description of embodiments is provided.

In accordance with one example configuration there is provided an apparatus comprising:
decoder circuitry responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing circuitry responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

The present techniques have realised the improvement in processing efficiency which may be achieved by the provision of a dedicated instruction-the reduce interpolation channel-wise instruction-and an apparatus responsive to that reduce interpolation channel-wise instruction to carry out a reduce interpolation channel-wise operation. Specifically, processing circuitry of the apparatus is provided which takes a range of source vectors and an interpolation vector as its input operands and performs weighted additions of selected elements taken from the range of source vectors with the respective resulting elements being stored in a destination vector also specified by the instruction. Both the selection of elements from the range of source vectors and the weighting employed for the weighted addition step of the respective element pairs are defined by the interpolation vector. That is, for each element of the interpolation vector, a first portion of that element dictates which pair of vectors from the range of source vectors are selected for processing, whilst a second portion of that element dictates the weighting of the weighted addition carried out between the pair of elements taken from the selected pair of vectors. Accordingly a particularly efficient encoding of the control of these two different aspects of the reduce interpolation channel-wise operation is provided.

The division of an element of the interpolation vector into the first portion and the second portion may be variously achieved, but in some examples the first portion of that element of the interpolation vector is an integer portion of that element of the interpolation vector and the second portion of that element of the interpolation vector is a fractional portion of that element of the interpolation vector.

Moreover, the use of a second portion of an element of the interpolation vector to dictate the weighting of the weighted addition carried out between the pair of elements taken from the selected pair of vectors may be variously achieved. However in some examples, the weighting of the weighted addition comprises a first weighting applied to a first element from a first vector of the pair of vectors and a second weighting applied to a second element from a second vector of the pair of vectors. Thus the element of the interpolation vector can provide a first weighting and a second weighting (according to a predetermined manner of generation of the two weightings from the element value).

In some examples the first weighting and the second weighting sum to 1. Thus for example, the second portion of an element of the interpolation vector may directly provide one of the first weighting and the second weighting and the other weighting is then determined by the difference of that second portion from 1.

The range of source vectors may be specified by the reduce interpolation channel-wise instruction in a variety of ways, but in some examples the reduce interpolation channel-wise instruction specifies the range of source vectors using a starting source vector and an ending source vector.

In some examples the reduce interpolation channel-wise instruction specifies the range of source vectors using a starting source vector and range value defining a number of vectors in the range of source vectors.

The apparatus may comprise issue circuitry configured to issue an instruction to the processing circuitry for execution when its operands are locally available to the processing circuitry. Generally, such issue circuitry may defer issuing a first instruction until this is the case in seeking to achieve a high instruction throughput, since the operands of a second instruction (which may have been received later by the instruction circuitry) may be ready sooner and that second instruction could make good progress in (or even complete) execution before the operands of the first instruction are ready. However, the present techniques recognise that whilst the execution of a reduce interpolation channel-wise instruction may involve several source vectors, the operation carried out is iterative and therefore it is possible for progress in the operation to be made before all of the source vectors are locally available to the processing circuitry. Accordingly, some examples further comprises issue circuitry configured to issue an instruction to the processing circuitry for execution when an operand defined by the instruction is locally available to the processing circuitry, wherein the issue circuitry is responsive to the control signals to issue the reduce interpolation channel-wise instruction to the processing circuitry to commence the reduce interpolation channel-wise operation when a first vector of the range of source vectors is locally available.

The processing circuitry may take a variety of forms, such as forming part of an instruction execution pipeline, as part of a multichannel compute unit comprising multiple processing elements, as part of a vector engine specifically configured for the processing of vectorised data, and so on.

In some examples the processing circuitry further comprises: a configurable compute unit to perform parallel arithmetic-logical operations on plural data channels, wherein the configurable compute unit comprises plural processing units to perform the parallel arithmetic-logical operations on the plural data channels; and a complex reduce engine to perform at least some of the reduce interpolation channel-wise operation.

The selection step and the weighted addition step may be arranged to be performed in a variety of ways by such an apparatus, but in some examples the complex reduce engine is configured to perform the selection step and the configurable compute unit is configured to perform the weighted addition step. In other examples the complex reduce engine is configured to perform the selection step and the weighted addition step.

In accordance with one example configuration there is provided an apparatus comprising:
decoder circuitry responsive to a 2D selection instruction to generate control signals to trigger a 2D selection operation, wherein the 2D selection instruction specifies a range of source vectors, an index vector, and a destination vector, each vector having a number of elements; and
processing circuitry responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

In the context of performing reduce interpolation channel-wise operations the present techniques have further recognised that it is advantageous to provide a further configuration of an apparatus in which a 2D selection instruction is defined, which enables the programmer to freely select elements from a range of source vectors in dependence on an index vector and for those selected element to provide the respective elements for a destination vector. Accordingly, this operation may be employed in the course of a reduce interpolation channel-wise operation, but usefully may also find applicability in other contexts as well.

The range of source vectors may be specified by the 2D selection instruction in a variety of ways, but in some examples the 2D selection instruction specifies the range of source vectors using a starting source vector and an ending source vector.

In some examples the 2D selection instruction specifies the range of source vectors using a starting source vector and range value defining a number of vectors in the range of source vectors.

As mentioned the 2D selection instruction may find application in a variety of contexts, but may be used as part of the performance of a reduce interpolation channel-wise operation. Accordingly, in some examples, the decoder circuitry is responsive to a sequence of instructions to generate control signals to trigger a reduce interpolation channel-wise operation, wherein the sequence of instructions comprises:
a preparation set of instructions specifying an interpolation vector, wherein the preparation set of instructions is configured to cause a first index vector and a second index vector to be generated in dependence on an first portion of each element of the interpolation vector and to cause a weighting vector and a complementary weighting vector to be generated in dependence on a second portion of each element of the interpolation vector;
a first 2D selection instruction specifying the range of source vectors, the first index vector, and a first destination vector; and
a second 2D selection instruction specifying the range of source vectors, the second index vector, and a second destination vector; and
a first multiply instruction configured to cause a product of the first destination vector and the weighting vector to be stored in a result vector; and
a second multiply accumulate instruction configured to cause a product of the second destination vector and the complementary weighting vector to be accumulated in the result vector.

The division of an element of the interpolation vector into the first portion and the second portion may be variously achieved, but in some examples the first portion of that element of the interpolation vector is an integer portion of that element of the interpolation vector and the second portion of that element of the interpolation vector is a fractional portion of that element of the interpolation vector.

In accordance with one example configuration there is provided a method comprising:
operating decoder circuitry which responds to a reduce interpolation channel-wise instruction by generating control signals to trigger a reduce interpolation channel-wise operation, wherein the reduce interpolation channel-wise instruction specifies a range of source vectors, an interpolation vector, and a destination vector, each vector having a number of elements; and
operating processing circuitry which responds to the control signals by performing the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

In accordance with one example configuration there is provided a method comprising:
operating decoder circuitry which responds to a 2D selection instruction to generate control signals to trigger a 2D selection operation, wherein the 2D selection instruction specifies a range of source vectors, an index vector, and a destination vector, each vector having a number of elements; and
operating processing circuitry which responds to the control signals to perform the 2D selection operation comprising, for each element of the number of elements:
   selecting a selected vector of the range of source vectors, wherein the selected vector is selected in dependence on an element value of that element of the index vector; and
   copying that element from the selected vector of the range of source vectors to that element of the destination vector.

In accordance with one example configuration there is provided a non-transitory computer-readable medium storing program instructions for controlling a host data processing apparatus to provide an instruction execution environment comprising:
decoder program logic responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing program logic responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

In accordance with one example configuration there is provided a non-transitory computer-readable medium storing program instructions for controlling a host data processing apparatus to provide an instruction execution environment comprising:
decoder program logic responsive to a 2D selection instruction to generate control signals to trigger a 2D selection operation, wherein the 2D selection instruction specifies a range of source vectors, an index vector, and a destination vector, each vector having a number of elements; and
processing program logic responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

Particular embodiments will now be described with reference to the figures.

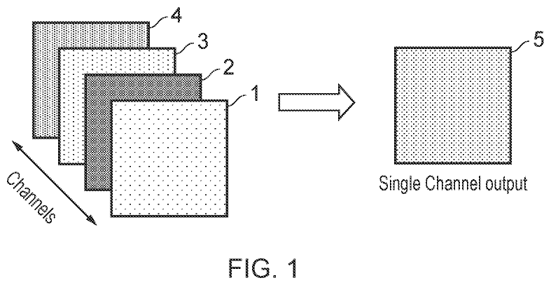

FIG. 1 schematically illustrates multiple input channels 1, 2, 3, 4 being processed to generate a single output channel 5. The input channels 1, 2, 3, 4 may for example represent multiple channels of an image. In the context of image channel data, the process shown is an image reduction process reducing the multiple input channels to a single output channel. Amongst a range of possible image reduction operations, a reduce interpolation channel-wise (RIC) operation involves a number of computational steps, since the operation comprises working through an element count of the vectors being processed and for each element: taking input values from a respective pair of selected elements from the range of source vectors, interpolating between those values using a given weighting, and storing the resulting value in the corresponding element of the destination vector. Thus in order to better support the performance of such a RIC operation two new instructions/apparatuses are disclosed herein. The first is a dedicated RIC instruction and an apparatus responsive to that RIC instruction to carry out a RIC operation. A range of source vectors and an interpolation vector provide the input operands and the result is stored in a destination vector. Advantageously, the interpolation vector dictates both the selection of elements from the range of source vectors and the weighting employed for the weighted addition step of the respective element pairs, providing a particularly efficient encoding of the control of these two different aspects of the RIC operation. The second is a “2D” vector selection instruction and an apparatus responsive to that 2D selection instruction to carry out the selection for specified elements from a range of source vectors for storage in the respective elements of a destination vector. This may be employed in the performance of a RIC operation, but usefully may also find applicability in other contexts as well. These instructions and apparatuses are described in more detail below.

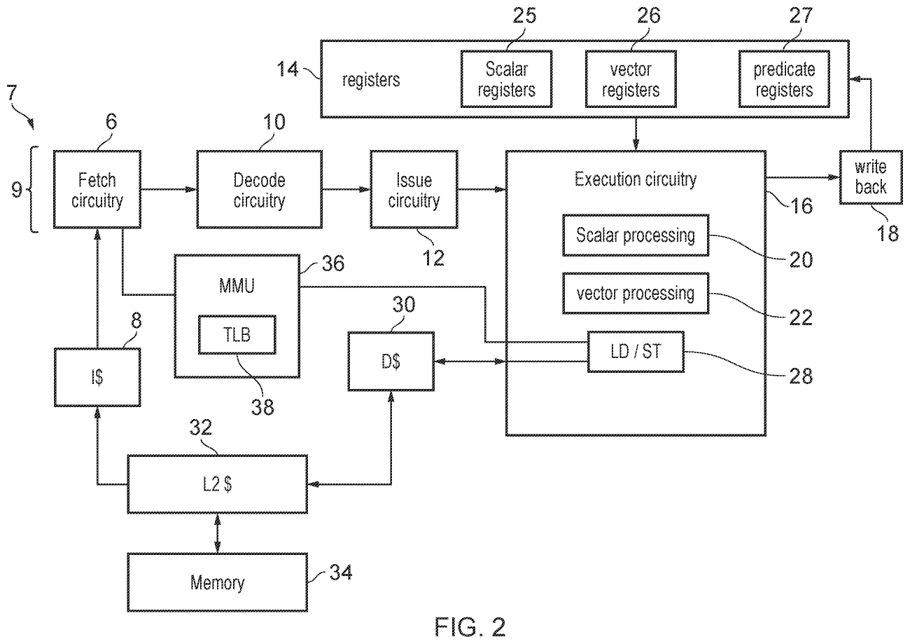

FIG. 2 schematically illustrates an apparatus 7 in accordance with some examples. The data processing apparatus has a processing pipeline 9, which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline arrangement, and other systems may have additional stages or a different configuration of stages. For example, in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units (processing circuitry), for executing different classes of processing operation. For example, the execution units may include a scalar processing unit 20 (e.g. comprising a scalar arithmetic/logic unit (ALU) 20 for performing arithmetic or logical operations on scalar operands read from the registers 14); a vector processing unit 22 for performing vector operations on vectors comprising multiple data elements; and a load/store unit 28 for performing load/store operations to access data in a memory system 8, 30, 32, 34. In the context of the present disclosure it is the vector processing unit 22 which provides the processing circuitry for performing the RIC vector operations. Other examples of processing units which could be provided at the execute stage could include a floating-point unit for performing operations involving values represented in floating-point format, or a branch unit for processing branch instructions.

The registers 14 include scalar registers 25 for storing scalar values, vector registers 26 for storing vector values, and predicate registers 27 for storing predicate values. The predicate values 27 may be used by the vector processing unit 22 when processing vector instructions, with a predicate value in a given predicate register indicating which data elements of a corresponding vector operand stored in the vector registers 26 are active data elements or inactive data elements (where operations corresponding to inactive data elements may be suppressed or may not affect a result value generated by the vector processing unit 22 in response to a vector instruction).

A memory management unit (MMU) 36 controls address translations between virtual addresses (specified by instruction fetches from the fetch circuitry 6 or load/store requests from the load/store unit 28) and physical addresses identifying locations in the memory system, based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached in a translation lookaside buffer (TLB) 38 which is a cache maintained by the MMU 36 for caching page table entries or other information for speeding up access to page table entries from the page table structure shown in memory.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 2 is merely a simplified representation of some components of a possible processor pipeline arrangement, and the processor may include many other elements not illustrated for conciseness.

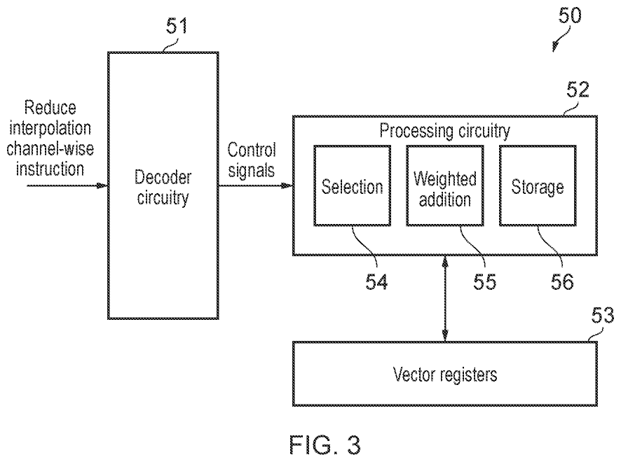

FIG. 3 schematically illustrates an apparatus 50 responsive to a reduce interpolation channel-wise instruction in accordance with some examples. This figure shows a conceptual view of the high-level components supporting the present techniques. The apparatus 50 comprises decoder circuitry 51, which is responsive to a reduce interpolation channel-wise instruction to generate control signals to trigger a reduce interpolation channel-wise operation. The control signals determine the operation of the processing circuitry 52. The processing circuitry has access to vector registers 53 amongst which the reduce interpolation channel-wise instruction specifies a range of source vectors, an interpolation vector, and a destination vector. In performing the reduce interpolation channel-wise operation, the processing circuitry makes use of the selection circuitry 54, which selects a pair of vectors from the range of source vectors (as steered by the interpolation vector). Its weighted addition circuitry 55 then performs a weighted addition of elements from the pair of vectors (as steered by the interpolation vector). Finally, its storage circuitry 56 stores a result of the weighted addition in the appropriate element of the destination vector.

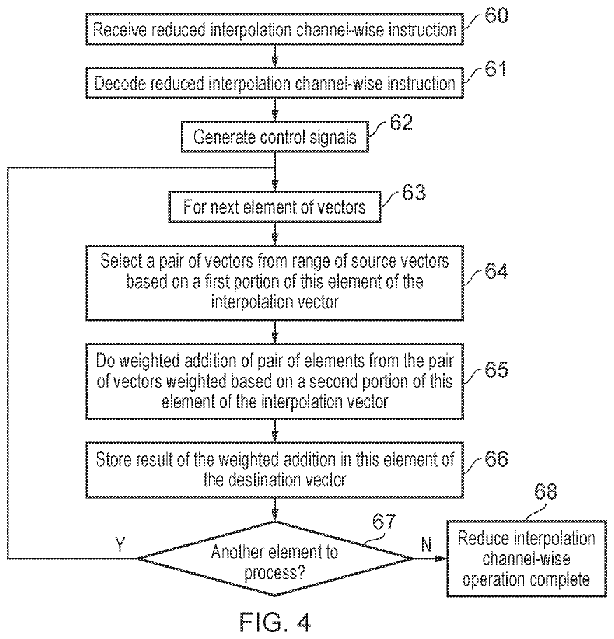

FIG. 4 shows a sequence of steps that are taken when performing a reduce interpolation channel-wise operation according to the method of some examples. The flow begins at step 60 when a reduce interpolation channel-wise instruction is received. At step 61, the reduce interpolation channel-wise instruction is decoded and on that basis at step 62 control signals are generated to trigger a reduce interpolation channel-wise operation. The reduce interpolation channel-wise instruction loops through each element of the number of elements of the vectors being processed and for each element of the number of elements (step 63): firstly (at step 64) a selection is performed of a pair of vectors from the range of source vectors (in dependence on a first portion of that element of the interpolation vector); then (at step 65) a weighted addition is performed of that element from the pair of vectors (where a weighting of the weighted addition is dependent on a second portion of that element of the interpolation vector); and finally (at step 66) the result of the weighted addition is stored in the current element of the destination vector. At step 67 it is determined if all vector elements have been processed, and when there is another element to process the flow returns to step 63. Once all vector elements have been processed, the flow concludes at step 68.

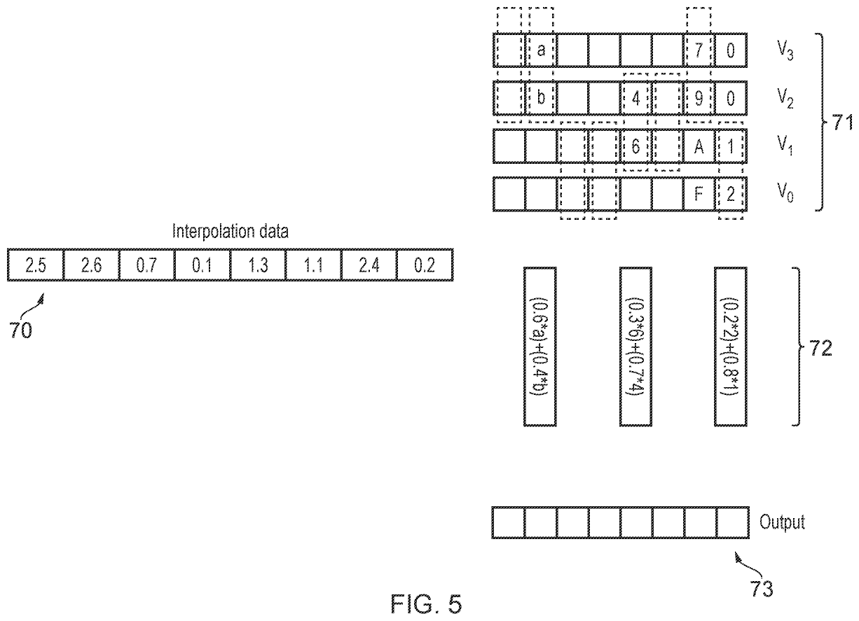

FIG. 5 schematically illustrates the use of a vector of interpolation data 70 to combine multiple input vectors 71 into a single output vector 73 in accordance with some examples. The vector of interpolation data 70 is specified by the RIC instruction is one of its input operands as well as the range of source vectors V₀ to V₃ as its other input operands. The destination (output) vector 73 is specified as a further operand of the RIC instruction. The respective values of the elements of the interpolation vector 70 dictate both the selection of a pair of elements from the source vectors between which will be interpolated and the weightings that will be applied to the respective elements of the pair of elements when performing that interpolation. For this purpose, a first portion of each element of the interpolation vector 70 is used to select the pair of elements, whilst a second portion of that element of the interpolation vector 70 is used to define the weightings. In this example, the respective elements of the interpolation vector 70 are fixed point values comprising an integer portion of the fractional portion. For example, the zeroth element of the interpolation vector 70 (in the rightmost position as illustrated) is shown to hold the value “0.2”, and hence the integer part “0” is used to dictate the selection of a pair of elements from the source vectors 71, whilst the fractional part “0.2” is used to dictate the weightings applied to that pair of elements when the interpolation calculation is performed. The selection of the pair of elements from the source vectors 71 is so arranged in the illustrated example that the integer part of the corresponding interpolation vector element specifies an adjacent pair of elements in the source vectors 71. The elements are adjacent in the sense that when a first element of the pair is taken from a first vector of the source vectors 71, the second element of that pair is taken from a second vector of the source vectors 51 that is numerically adjacent in the enumeration of the source vectors 71. Hence in the example of the zeroth element of the interpolation vector 70, the integer part “0” of the value of that element specifies that the first element of the selected pair comes from vector V₀ and the second element of the selected pair comes from vector V₁. In the illustrated example these elements hold the values 2 and 1 respectively. The interpolation between these values is then performed applying the weightings defined by the fractional portion “0.2” of the zeroth element of the interpolation vector 70. Specifically, a weighting of 0.2 is applied to the first element taken from vector V₀ and a weighting of 0.8 is applied to the second element taken from vector V₁. It will be understood therefore that the weighting for the second element is calculated by subtracting the weighting for the first element from 1. The interpolation calculation (as illustrated) is then ((0.2*2)+(0.8*1)) and the resulting value (1.2) is then stored in the zeroth element of the output vector 73. The RIC operation proceeds iteratively through the vector elements, selecting a pair of elements from the sources vectors 51 according to the integer portion of the corresponding element of the interpolation vector, and combining their respected values weighted in dependence on the fractional portion of the corresponding element of the interpolation vector, with the result being stored in the corresponding element of the output vector 73. As shown by the dashed lines encircling pairs of elements of the source vectors 71: an integer portion value of 0 in the interpolation vector causes the selected element pair to be taken from vectors V₀ and V₁; an integer portion value of 1 in the interpolation vector causes the selected element pair to be taken from vectors V₁ and V₂; and an integer portion value of 2 in the interpolation vector causes the selected element pair to be taken from vectors V₂ and V₃. Example interpolation calculations for elements 3 and 6 are also shown as ((0.3*6)+(0.7*4)) and ((0.6*a)+(0.4*b)) respectively. It should be noted that the present techniques may also make use of an interpolation vector which holds element values specified in floating point format (instead of fixed point format), where the same principle holds for specifying the element pair selection and the weightings, where this refers to the significand part of the floating point value i.e. that a first portion of the significand of each element value determines the element pair selection and a second portion of the significand of each element value determines the weightings.

The reduce interpolation channel-wise (RIC) operation may be initiated by an instruction forming part of the instruction set architecture (ISA) for the apparatus (such as, for example, apparatus 7 in FIG. 2). Such a RIC instruction is thus retrieved by the fetch circuitry 6 as part of the sequence of instructions being executed and is decoded by decode circuitry 10. The decode circuitry 10 has a configuration to recognise the unique opcode of the RIC instruction and to generate the corresponding control signals to cause the RIC operation to be carried out by the vector processing execution unit 22 of the execution circuitry 16. Two example forms of the RIC instruction are given below:
1) RIC Zd, zm, {zstart-zend}
2) RIC Zd, zm, {zstart, #range}
   where
Zd—destination register
Zm—holds the interpolation vector
Zstart—vector register from which to start performing interpolation
Zend—last vector register on which to perform interpolation
range—if Zend is not used, this can specify the number of registers to use.
   For example:
   RIC Zd, Zm, {z0, z1, z2, z3} #Interpolation across 4 channels
   RIC Zd, Zm, {z0, z1, z2, z3, z4, z5, z6, z7} #Interpolation across 8 channels

The RIC operations initiated by the RIC instructions may be carried out by the vector processing execution unit 22 of the execution circuitry 16, which may comprise a specialised “complex reduce engine” block incorporated in a SIMD (single instruction multiple data) pipeline of the vector processing execution unit. The number of cycles required to perform the operations depends on the number of channels being processed, such that in the above example operations are completed in 4 and 8 clock cycles respectively. It is further to be noted that the apparatus 7 may be configured such that, when a RIC instruction is decoded and is queued in the issue circuitry 12, instead of waiting for all the vectors is specifies to be loaded, the instruction can get issued when the first vector is available and the dependency is tracked further to ensure further iterations are executed as and when register dependency is resolved. This approach is of particular benefit in very wide vector implementations (e.g. 512 bits). Hence, instead of loading all 8 channels in 8 different registers and only commencing the computation then, the RIC can make progress as and when register dependencies are resolved.

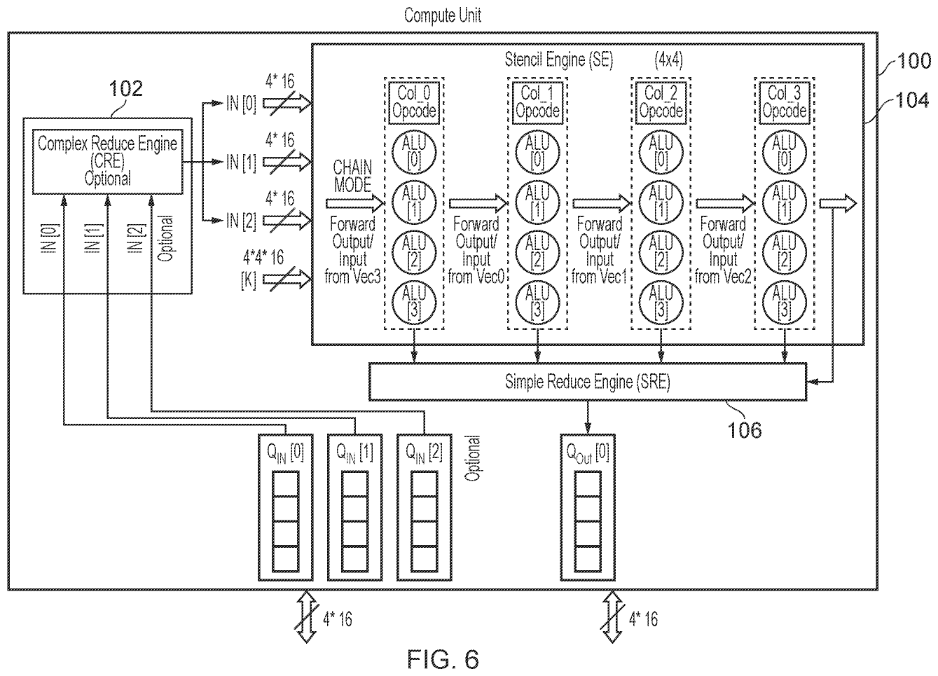

FIG. 6 schematically illustrates a compute unit 100 comprising a complex reduce engine 102, a stencil engine 104, and a simple reduce engine 106 in accordance with some examples. The compute unit 100 is an instance of the processing circuitry on which the present techniques are implemented in some examples. Generally, the compute unit 100 is arranged to perform parallel arithmetic-logical operations on plural data channels, such as are often required in the context of image processing. For this purpose the compute unit 100 receives at least two vectors of input data (three are shown in the example of FIG. 6: Q_{IN}[0], Q_{IN}[1], and Q_{IN}[2]). In this example the data from multiple channels arrive on Q_{IN}[0] and the interpolation vector arrives on Q_{IN}[1]. Q_{IN}[2] may be used provide additional configuration parameters, such as the opcode of the operation to be carried out (of which one example is the RIC operation) and the number of channels to be processed. In general input data for processing and configuration data may be received directly by the stencil engine 104, but in the example shown these are first received by the complex reduce engine (CRE) 102. Moreover in this example the complex reduce engine (CRE) 102 is configured to perform at least some of the RIC operation. Hence the CRE 102 receives the data from multiple channels on QIN [0] and the interpolation vector on QIN [1]. The CRE 102 is configured to handle image reduction operations, such as the RIC. From the CRE 102 the partially processed channels of data are forwarded to the stencil engine 104, which is configured as a grid of processing elements (PEs), such that it can perform multi-channel, multi-cycle operations. As shown in the figure, the stencil engine 104 may be operated in a “chain mode” in which columns of PEs (in this example ALUs) which are grouped into columns (four columns in the example shown) forward their output to the next column in the chain. This forwarding may wrap-around with the output of column 3 providing the input to column 0, depending on the nature of the operations being performed. Each column is configured in accordance with an opcode. The output of the set of PEs in the stencil engine 104 is passed to the simple reduce engine (SRE) 106, which may for example take the form of an accumulator to generate output channel data, which is passed on as Q_{Out}. Not all PEs in the stencil engine 104 will necessarily perform multi-cyle operations and the configuration to handle multi-cycle operations can be selectively introduced in some of the elements in the grid of PEs. This is primarily because image reduction operations usually occur once or twice in an image pipeline. In a grid of 4×4 PEs, 1 CRE block could be implemented for every 8/4 PEs (picked at design time based on use case).

In a variant of the example shown in FIG. 6, the function of the complex reduce engine 102 may instead be at least partially absorbed into the stencil engine 104, whereby the first column of PEs in the stencil engine 104 is adapted to handle multi-cycle operations (splitting functionality between the CRE 102 and the first column in the SE 104). In this approach, the CRE 102 is then used for generating the vector data from the interpolation vector and the first column of ALUs of the SE 104 then handles subsequent multi-cycle operations. This set of ALUs is aware of the cycle count they need to respect before forwarding data to the next column. This approach could lead to better utilization of the ALUs in the stencil engine (depending on the use case), but makes the stencil engine non-uniform.

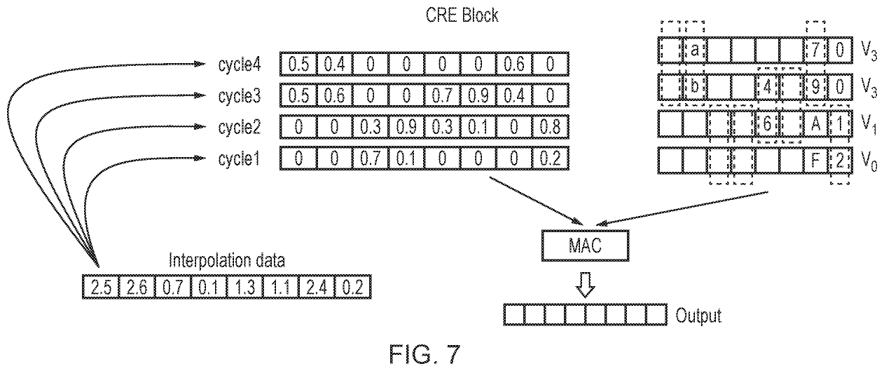

FIG. 7 schematically illustrates some operations carried out by a complex reduce engine in accordance with some examples. This is based on the example of FIG. 5. The algorithm used in this example to generate the output vector on the basis of the input vectors V₀-V₃ and the interpolation data vector is as follows:

```
  output_vector = 0;
  lane_selection_cur_iter = 0;
  lane_selection_prev_iter = 0;
  for (n=1; n <= num_channels; n++) // in Figure 7 num_channels=4
{
```

Step 1) Subtract interpolation vector with value ‘n’ and ‘n−1’ where ‘n’ is the cycle number, i.e. in cycle 1, subtracting the values ‘1’ and ‘0’ from the interpolation vector:

$$sub\_result \_nxt \_cycle = \{ interpolation\_vector \} - n$$

$$sub\_result \_cur \_cycle = \{ interpolation\_vector \} - ( n - 1 )$$

Step 2) The lanes which have negative numbers in sub_result_nxt_cycle and positive numbers in sub_result_cur_cycle are easy to spot and are used to determine lanes (lane_selection_cur_iter), and the lane selection is then built on that of the previous iteration:
lane_selection=lane_selection_cur_iter OR lane_selection_prev_iter;

Step 3) Once the lanes are known, the output vector is generated by accumulating in output_vector the result of multiplying ABS[sub_result_cur_cycle] by the relevant input vector V[i], masked by lane_selection, i.e.:

```
  {ABS[sub_result_cur_cycle]&&(lane_selection) * V[n−1]} is
accumulated in output_vector // This is performed by
the MAC unit
  lane_selection_prev_iter = lane_selection_cur_iter;
}
```

As a worked example for just one element of the interpolation vector (taking the send left-hand most element (element 6) shown in FIG. 7 of 2.6):

| | |
|---|---|
| Interpolation vector (element) | 2.6 |

output_vector=0;
lane_selection_prev_iter=0;

### Cycle 1

| | |
|---|---|
| sub_result_nxt_cycle | 1.6 |
| sub_result_cur_cycle | 2.6 |
| lane_selection_cur_iter | 0 |
| lane_selection | 0 |
| output_vector | 0 |
| Lane_selection_prev_iter | 0 |

### Cycle 2

| | |
|---|---|
| sub_result_nxt_cycle | 0.6 |
| sub_result_cur_cycle | 1.6 |
| lane_selection_cur_iter | 0 |
| lane_selection | 0 |
| output_vector | 0 |
| lane_selection_prev_iter | 0 |

### Cycle 3

| | |
|---|---|
| sub_result_nxt_cycle | −0.4 |
| sub_result_cur_cycle | 0.6 |
| lane_selection_cur_iter | 1 |
| lane_selection | 1 |
| output_vector | 0.6*V₂[6] |
| lane_selection_nxt_cycle | 1 |

### Cycle 4

| | |
|---|---|
| sub_result_nxt_cycle | −1.5 |
| sub_result_cur_cycle | −0.5 |
| lane_selection_cur_iter | 0 |
| lane_selection | 1 |
| output_vector | 0.6*V₂[6] + 0.4*V₃[6] |
| lane_selection_nxt_cycle | 0 |

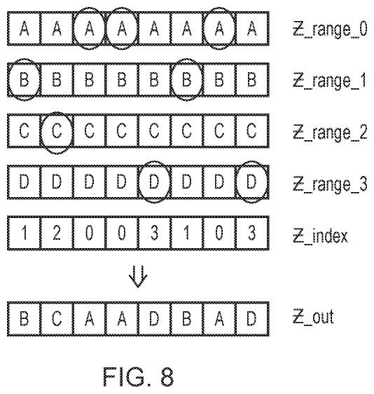

FIG. 8 schematically illustrates a 2D selection operation in accordance with some examples. The present techniques further provide a further configuration of an apparatus in which a 2D selection instruction is defined, which enables the programmer to freely select elements from a range of source vectors in dependence on an index vector and for those selected element to provide the respective elements for a destination vector. Accordingly, this operation may be employed in the course of a reduce interpolation channel-wise operation, but usefully may also find applicability in other contexts as well. The example shown in FIG. 8 illustrates the generation of an output vector z_out, where its elements are selected from a range of source vectors {z_range_0, z_range_1, z_range_2, z_range_3} in dependence on an index vector z_index, The respective elements of the index vector z_index each determine from which of the source vectors the corresponding element will be copied in to z_out.

The semantics of the 2D selection instruction may for example take the form:

SEL2D z_out, z_index, {z_range_0, z_range_1, z_range_2, z_range_3}

where z_out, z_index, and z_range_i are the vectors defined above with reference to the example of FIG. 8. The example is given of there being four source vectors in the set z_range_i, but this is purely exemplary and more or fewer source vectors may be specified. Whilst applicable in a range of vector processing contexts, the SEL2D instruction can be used to implement a RIC operation, as is set out in the following (where z_interp is the interpolation vector):

| BIC z_f, z_interp, #<integer bits> | # Calculate “f” (z_f) by clearing the |
|---|---|
| | integer part of z_interp |
| SUB z_omf, {one_register}, {z_f} | # Calculate “1−f” (z_omf) |
| LSR z_index, z_interp, #<num frac. bits> | # extract integer part of z_interp |
| ADD z_index_plus_1, z_index, #1 | # and add one to it |

| | |
|---|---|
| SEL2D z_chA, z_index, {<range of input regs>} | # pick out chA |
| SEL2D z_chB, z_index_plus_1, {<range of input regs>} | # pick out chB |

| | |
|---|---|
| MUL z_acc, z_chA, z_f | # write the first part of the weighted sum |
| MLA z_acc, z_chB, z_omf | # accumulate the second part of the weighted sum |

Implemented in a two-wide out-of-order (OoO) single instruction multiple data (SIMD) engine for four channel interpolation the above code runs in 4 clock cycles. For eight channel interpolation SEL2D can be implemented as a two-cycle operation, according to which firstly the SEL2D operations on four channels, followed by another SEL2D for the remaining four channels.

The above code comprises the use of two SEL2D instructions, the first using z_index to pick out chA and the second using z_index_plus_1 to pick out chB. A variant of the SEL2D instruction is also disclosed here (the “SEL2D (Hi.Lo)” variant), which returns two registers one using “z_index” and the other uses “z_index_plus_1” in a single instruction. This therefore may have the example semantic form:

SEL2D z_out1, z_out_2, z_index, {z_range_0, . . . , z_range_n}

The SEL2D instruction has a number of advantages over known table vector lookup (TBL) instructions. For example some TBL varieties support a range of up to 4 registers, although they then always work on byte elements and byte-based indices. Hence in the case that the elements are not bytes, setting up the indices is laborious (it can be done, but not in a single instruction). Other varieties of TBL support a range of up to 2 registers, where the index is element-based, not column-based. This then imposes the additional burden here of needing to covert column indices to element indices. Moreover a TBL instruction is a full permute/shift block, such that any element in the multiple registers can map to any other location in the final output based on index value. Whilst this has a benefit of flexibility, it comes at a significant constructional cost, with switchable connections needing to be provided between all source elements to all output elements. By contrast, SEL2D does not need this full flexibility in mapping, with only the need to map elements in a particular lane in multiple registers to the same lane in the final output. This makes the implementation in hardware of SEL2D simpler and likely faster when compared to TBL. Finally, as mentioned above for the RIC instruction, the SEL2D instruction can also take advantage of implementation in a CRE block, whereby required data in the vector registers can be made use of as and when they arrive. In the case of TBL, this is not possible because of the full permute capability.

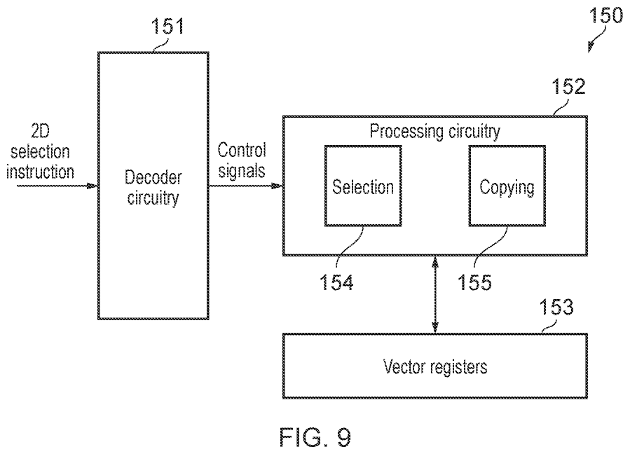

FIG. 9 schematically illustrates an apparatus 150 responsive to a 2D selection instruction in accordance with some examples. This figure shows a conceptual view of the high-level components supporting the present techniques. The apparatus 150 comprises decoder circuitry 151, which is responsive to a 2D selection instruction to generate control signals to trigger a 2D selection operation. The control signals determine the operation of the processing circuitry 152. The processing circuitry has access to vector registers 153 amongst which the 2D selection instruction specifies a range of source vectors, an index vector, and a destination vector. In performing the 2D selection operation, the processing circuitry makes use of the selection circuitry 154, which for each element of size of vectors used, selects selected vector from the range of source vectors (as steered by the index vector). The copying circuitry 155 then copies the current element from the selected vector of the range of source vectors to that element of the destination vector.

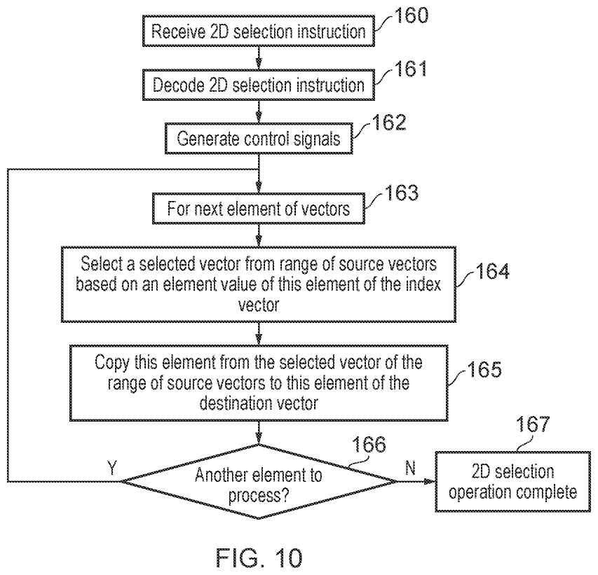

FIG. 10 shows a sequence of steps that are taken when performing a 2D selection operation according to the method of some examples. The flow begins at step 160 when a 2D selection instruction is received. At step 161, the 2D selection instruction is decoded and on that basis at step 162 control signals are generated to trigger a 2D selection operation. The 2D selection instruction loops through each element of the number of elements of the vectors being processed and for each element of the number of elements (step 163): firstly (at step 164) a selection is performed of a source vectors from the range of source vectors (in dependence on the corresponding element value in the index vector); and then (at step 165) this element from the selected vector is copies to the destination vector. At step 166 it is determined if all vector elements have been processed, and when there is another element to process the flow returns to step 163. Once all vector elements have been processed, the flow concludes at step 167.

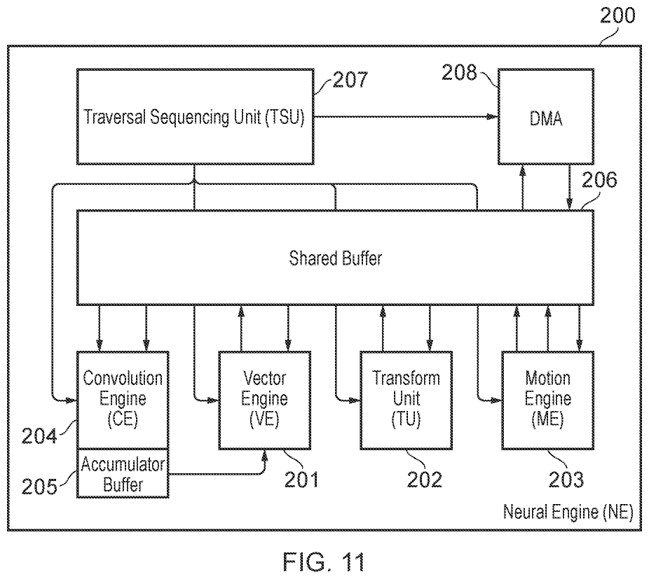

FIG. 11 schematically illustrates a neural engine 200 in accordance with some examples. The neural engine 200 is shown to comprise vector engine (VE) 201, a transform unit (TU) 202, a motion engine (ME) 203, and a convolution engine (CE) 204 with associated accumulation buffer 205. These components share access to the shared buffer 206, which holds the data being processed. The control over the ordering of the data to be processed is handled by a traversal sequencing unit (TSU) 207 in conjunction with DMA 208 (which interfaces with the memory system to retrieve data to be processed and to store the data that has been processed). For the purposes of the present disclosure, it is only required to focus on the vector engine 201, which provides the processing circuitry that implements the RIC operation.

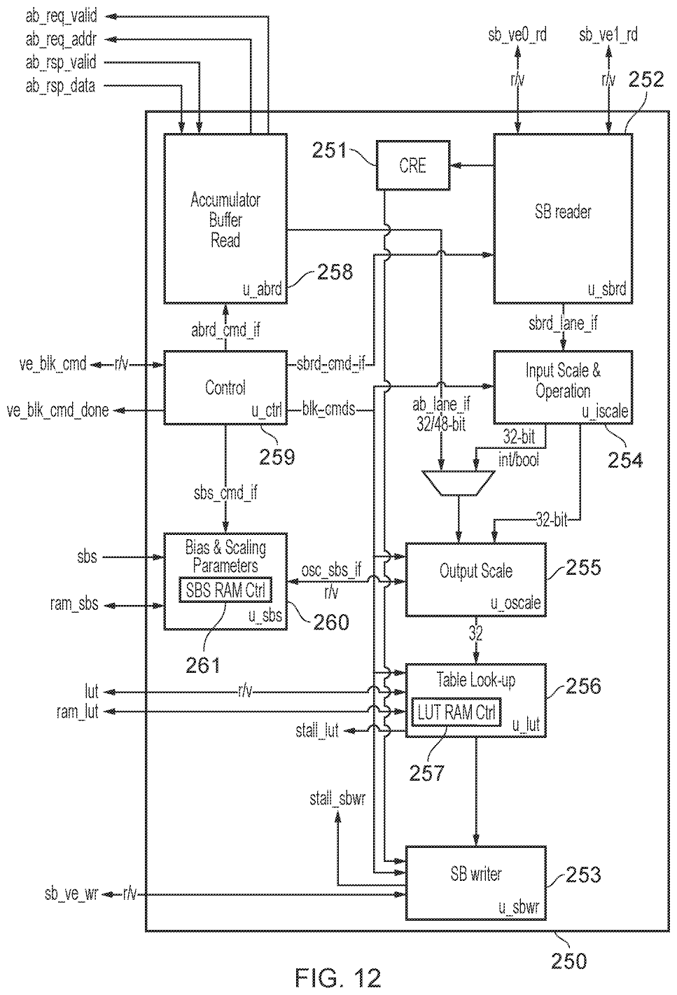

FIG. 12 schematically illustrates a vector engine 250 in accordance with some examples. This vector engine may provide the VE 201 shown in FIG. 11. Furthermore, in accordance with the present techniques, the vector engine 250 comprises a complex reduce engine (CRE) 251, which is configured as described elsewhere herein to perform RIC operations. The CRE 251 is shown to lie on a processing path between the shared buffer (SB) reader 252 and the SB writer 253. Accordingly, (image) data retrieved from the shared buffer on multiple channels by SB reader 252 can be subjected to a RIC operation by the CRE 251, before the output channel so generated can be written back to the shared buffer by the SB writer 253. Further components of the VE 250 illustrated for context, but not of direct significance to the present techniques, are the input scale & operation block 254, the output scale block 255, the table look-up block 256 (comprising the look-up table (LUT) RAM control 257, the accumulator buffer read block 258, the control block 259, and the bias & scaling parameters block 260 (comprising the SBS RAM Control 261).

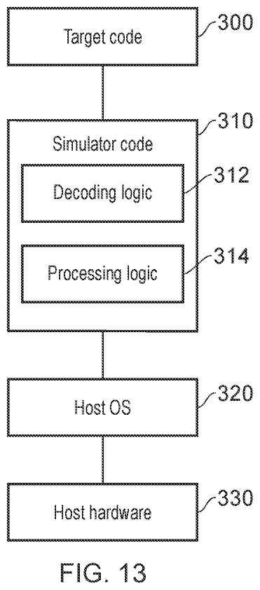

FIG. 13 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 330, optionally running a host operating system 320, supporting the simulator program 310. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 330), some simulated embodiments may make use of the host hardware, where suitable.

The simulator program 310 may be stored on a computer-readable storage medium (which may be a non-transitory medium), and provides a program interface (instruction execution environment) to the target code 300 (which may include applications, operating systems and a hypervisor) which is the same as the interface of the hardware architecture being modelled by the simulator program 310. Thus, the program instructions of the target code 300 may be executed from within the instruction execution environment using the simulator program 310, so that a host computer 330 which does not actually have the hardware features of the apparatuses 7, 50, or 150 discussed above can emulate these features.

For example, the simulator program may specify one or more instances of decoding logic 312 and processing logic 314. The decoding logic 312 generates control signals to control the processor logic 314. The processor logic 314 may be specified to emulate the features of, for example, the apparatus 7 as described in relation to FIG. 2, the apparatus 50 described in relation to FIG. 3, or the apparatus 150 described in relation to FIG. 9.

Various disclosed configurations according to the present techniques are set out in the following numbered clauses:

Clause 1. Apparatus comprising:
decoder circuitry responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing circuitry responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

Clause 2. The apparatus as defined in Clause 1, wherein the first portion of that element of the interpolation vector is an integer portion of that element of the interpolation vector and the second portion of that element of the interpolation vector is a fractional portion of that element of the interpolation vector.

Clause 3. The apparatus as defined in Clause 1 or Clause 2, wherein the weighting of the weighted addition comprises a first weighting applied to a first element from a first vector of the pair of vectors and a second weighting applied to a second element from a second vector of the pair of vectors.

Clause 4. The apparatus as defined in Clause 3, wherein the first weighting and the second weighting sum to 1.

Clause 5. The apparatus as defined in any of Clauses 1-4, wherein the reduce interpolation channel-wise instruction specifies the range of source vectors using a starting source vector and an ending source vector.

Clause 6. The apparatus as defined in any of Clauses 1-4, wherein the reduce interpolation channel-wise instruction specifies the range of source vectors using a starting source vector and range value defining a number of vectors in the range of source vectors.

Clause 7. The apparatus as defined in any preceding Clause, further comprising issue circuitry configured to issue an instruction to the processing circuitry for execution when an operand defined by the instruction is locally available to the processing circuitry,
wherein the issue circuitry is responsive to the control signals to issue the reduce interpolation channel-wise instruction to the processing circuitry to commence the reduce interpolation channel-wise operation when a first vector of the range of source vectors is locally available.

Clause 8. The apparatus as defined in any preceding Clause, wherein the processing circuitry further comprises:
a configurable compute unit to perform parallel arithmetic-logical operations on plural data channels, wherein the configurable compute unit comprises plural processing units to perform the parallel arithmetic-logical operations on the plural data channels; and
a complex reduce engine to perform at least some of the reduce interpolation channel-wise operation.

Clause 9. The apparatus as defined in Clause 8, wherein:
the complex reduce engine is configured to perform the selection step and the configurable compute unit is configured to perform the weighted addition step.

Clause 10. The apparatus as defined in Clause 8, wherein:
the complex reduce engine is configured to perform the selection step and the weighted addition step.

Clause 11. Apparatus comprising:
decoder circuitry responsive to a 2D selection instruction to generate control signals to trigger a 2D selection operation, wherein the 2D selection instruction specifies a range of source vectors, an index vector, and a destination vector, each vector having a number of elements; and
processing circuitry responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

Clause 12. The apparatus as defined in Clause 11, wherein the 2D selection instruction specifies the range of source vectors using a starting source vector and an ending source vector.

Clause 13. The apparatus as defined in Clause 11, wherein the 2D selection instruction specifies the range of source vectors using a starting source vector and range value defining a number of vectors in the range of source vectors.

Clause 14. The apparatus as defined in any of Clauses 11 to 13, wherein the decoder circuitry is responsive to a sequence of instructions to generate control signals to trigger a reduce interpolation channel-wise operation, wherein the sequence of instructions comprises:
a preparation set of instructions specifying an interpolation vector, wherein the preparation set of instructions is configured to cause a first index vector and a second index vector to be generated in dependence on an first portion of each element of the interpolation vector and to cause a weighting vector and a complementary weighting vector to be generated in dependence on a second portion of each element of the interpolation vector;
a first 2D selection instruction specifying the range of source vectors, the first index vector, and a first destination vector; and
a second 2D selection instruction specifying the range of source vectors, the second index vector, and a second destination vector; and
a first multiply instruction configured to cause a product of the first destination vector and the weighting vector to be stored in a result vector; and
a second multiply accumulate instruction configured to cause a product of the second destination vector and the complementary weighting vector to be accumulated in the result vector.

Clause 15. The apparatus as defined in Clause 14, wherein the first portion of that element of the interpolation vector is an integer portion of that element of the interpolation vector and the second portion of that element of the interpolation vector is a fractional portion of that element of the interpolation vector.

Clause 16. A method comprising:
operating decoder circuitry which responds to a reduce interpolation channel-wise instruction by generating control signals to trigger a reduce interpolation channel-wise operation, wherein the reduce interpolation channel-wise instruction specifies a range of source vectors, an interpolation vector, and a destination vector, each vector having a number of elements; and
operating processing circuitry which responds to the control signals by performing the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

Clause 17. A method comprising:
operating decoder circuitry which responds to a 2D selection instruction to generate control signals to trigger a 2D selection operation, wherein the 2D selection instruction specifies a range of source vectors, an index vector, and a destination vector, each vector having a number of elements; and
operating processing circuitry which responds to the control signals to perform the 2D selection operation comprising, for each element of the number of elements:
   selecting a selected vector of the range of source vectors, wherein the selected vector is selected in dependence on an element value of that element of the index vector; and
   copying that element from the selected vector of the range of source vectors to that element of the destination vector.

Clause 18. A non-transitory computer-readable medium storing program instructions for controlling a host data processing apparatus to provide an instruction execution environment comprising:
decoder program logic responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing program logic responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

Clause 19. A non-transitory computer-readable medium storing program instructions for controlling a host data processing apparatus to provide an instruction execution environment comprising:
decoder program logic responsive to a 2D selection instruction to generate control signals to trigger a 2D selection operation, wherein the 2D selection instruction specifies a range of source vectors, an index vector, and a destination vector, each vector having a number of elements; and
processing program logic responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

In brief overall summary apparatuses, methods, and non-transitory computer-readable media are disclosed. One example concerns a reduce interpolation channel-wise instruction to trigger a reduce interpolation channel-wise operation. The reduce interpolation channel-wise operation comprises: selecting a pair of vectors from a range of source vectors in dependence on a first portion of each element of an interpolation vector; a weighted addition of that element from the pair of vectors, wherein a weighting of the weighted addition is dependent on a second portion of that element of the interpolation vector; and storing a result of the weighted addition in that element of a destination vector. Another example concerns a 2D selection instruction to trigger a 2D selection operation comprising, for each vector element: selecting a selected vector from a range of source vectors, wherein the selected vector is selected in dependence on an element value of that element of an index vector; and copying that element from the selected vector of the range of source vectors to that element of a destination vector.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
decoder circuitry responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing circuitry responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

2. The apparatus as claimed in claim 1, wherein the first portion of that element of the interpolation vector is an integer portion of that element of the interpolation vector and the second portion of that element of the interpolation vector is a fractional portion of that element of the interpolation vector.

3. The apparatus as claimed in claim 1, wherein the weighting of the weighted addition comprises a first weighting applied to a first element from a first vector of the pair of vectors and a second weighting applied to a second element from a second vector of the pair of vectors.

4. The apparatus as claimed in claim 3, wherein the first weighting and the second weighting sum to 1.

5. The apparatus as claimed in claim 1, wherein the reduce interpolation channel-wise instruction specifies the range of source vectors using a starting source vector and an ending source vector.

6. The apparatus as claimed in claim 1, wherein the reduce interpolation channel-wise instruction specifies the range of source vectors using a starting source vector and range value defining a number of vectors in the range of source vectors.

7. The apparatus as claimed in claim 1, further comprising issue circuitry configured to issue an instruction to the processing circuitry for execution when an operand defined by the instruction is locally available to the processing circuitry,
wherein the issue circuitry is responsive to the control signals to issue the reduce interpolation channel-wise instruction to the processing circuitry to commence the reduce interpolation channel-wise operation when a first vector of the range of source vectors is locally available.

8. The apparatus as claimed in claim 1, wherein the processing circuitry further comprises:
a configurable compute unit to perform parallel arithmetic-logical operations on plural data channels, wherein the configurable compute unit comprises plural processing units to perform the parallel arithmetic-logical operations on the plural data channels; and
a complex reduce engine to perform at least some of the reduce interpolation channel-wise operation.

9. The apparatus as claimed in claim 8, wherein:
the complex reduce engine is configured to perform the selection step and the configurable compute unit is configured to perform the weighted addition step.

10. The apparatus as claimed in claim 8, wherein:
the complex reduce engine is configured to perform the selection step and the weighted addition step.

11. Apparatus comprising:
decoder circuitry responsive to a 2D selection instruction to generate control signals to trigger a 2D selection operation, wherein the 2D selection instruction specifies a range of source vectors, an index vector, and a destination vector, each vector having a number of elements; and
processing circuitry responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

12. The apparatus as claimed in claim 11, wherein the 2D selection instruction specifies the range of source vectors using a starting source vector and an ending source vector.

13. The apparatus as claimed in claim 11, wherein the 2D selection instruction specifies the range of source vectors using a starting source vector and range value defining a number of vectors in the range of source vectors.

14. The apparatus as claimed in claim 11, wherein the decoder circuitry is responsive to a sequence of instructions to generate control signals to trigger a reduce interpolation channel-wise operation, wherein the sequence of instructions comprises:
a preparation set of instructions specifying an interpolation vector, wherein the preparation set of instructions is configured to cause a first index vector and a second index vector to be generated in dependence on an first portion of each element of the interpolation vector and to cause a weighting vector and a complementary weighting vector to be generated in dependence on a second portion of each element of the interpolation vector;
a first 2D selection instruction specifying the range of source vectors, the first index vector, and a first destination vector; and
a second 2D selection instruction specifying the range of source vectors, the second index vector, and a second destination vector; and
a first multiply instruction configured to cause a product of the first destination vector and the weighting vector to be stored in a result vector; and
a second multiply accumulate instruction configured to cause a product of the second destination vector and the complementary weighting vector to be accumulated in the result vector.

15. The apparatus as claimed in claim 14, wherein the first portion of that element of the interpolation vector is an integer portion of that element of the interpolation vector and the second portion of that element of the interpolation vector is a fractional portion of that element of the interpolation vector.

16. A method comprising:
operating decoder circuitry which responds to a reduce interpolation channel-wise instruction by generating control signals to trigger a reduce interpolation channel-wise operation, wherein the reduce interpolation channel-wise instruction specifies a range of source vectors, an interpolation vector, and a destination vector, each vector having a number of elements; and
operating processing circuitry which responds to the control signals by performing the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

17. A method comprising:
operating decoder circuitry which responds to a 2D selection instruction to generate control signals to trigger a 2D selection operation, wherein the 2D selection instruction specifies a range of source vectors, an index vector, and a destination vector, each vector having a number of elements; and
operating processing circuitry which responds to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.

18. A non-transitory computer-readable medium storing program instructions for controlling a host data processing apparatus to provide an instruction execution environment comprising:
decoder program logic responsive to a reduce interpolation channel-wise instruction to generate control signals to trigger a reduce interpolation channel-wise operation, wherein the reduce interpolation channel-wise instruction specifies a range of source vectors, an interpolation vector, and a destination vector, each vector having a number of elements; and
processing program logic responsive to the control signals to perform the reduce interpolation channel-wise operation comprising, for each element of the number of elements:
a selection step comprising selecting a pair of vectors from the range of source vectors in dependence on a first portion of that element of the interpolation vector;
a weighted addition step comprising performing a weighted addition of that element from the pair of vectors, wherein a weighting of the weighted addition is dependent on a second portion of that element of the interpolation vector; and
a storage step comprising storing a result of the weighted addition in that element of the destination vector.

19. A non-transitory computer-readable medium storing program instructions for controlling a host data processing apparatus to provide an instruction execution environment comprising:
decoder program logic responsive to a 2D selection instruction to generate control signals to trigger a 2D selection operation, wherein the 2D selection instruction specifies a range of source vectors, an index vector, and a destination vector, each vector having a number of elements; and
processing program logic responsive to the control signals to perform the 2D selection operation comprising, for each element of the number of elements:
selecting a selected vector of the range of source vectors, wherein the selected vector is selected in dependence on an element value of that element of the index vector; and
copying that element from the selected vector of the range of source vectors to that element of the destination vector.
